(19) United States
(12) Patent Application Publication
(10) Pub. No.: US 2026/0317235 A1
(43) Pub. Date: Oct. 15, 2026

(54) COMPOSITION AMD METHOD FOR FORMING HIGHLY FLEXIBLE CONCRETE REINFORCING BAR

(71) Applicant: SAUDI ARABIAN OIL COMPANY, Dhahran (SA)

(72) Inventors: Thibault Villette, Belfort (FR); Mohammed Al Mehthel, Dhahran (SA); Oscar Salazar Vidal, Dhahran (SA); Remi Mahfouz, Dhahran (SA); Abderrazak Traidia, Lussan (FR)

(73) Assignee: SAUDI ARABIAN OIL COMPANY, Dhahran (SA)

(21) Appl. No.: 19/179,174

(22) Filed: Apr. 15, 2025

(51) Int. Cl. C04B 20/10; C04B 14/42; C04B 16/06; C08J 3/24; C08J 5/24

(52) U.S. Cl. CPC C04B 20/1037; C04B 14/42; C04B 16/0683; C08J 3/247; C08J 5/248; C08J 2363/10

(57) ABSTRACT

Described is a fiber reinforced polymer rebar made from a first composite and a second composite. The first composite consists of glass fibers distributed in a polymer matrix. The second composite consists of polyethylene terephthalate fibers distributed in the polymer matrix. The first composite forms an inner portion of the fiber reinforced polymer rebar, and the second composite forms an outer portion of the fiber reinforced polymer rebar.

### BACKGROUND

Reinforced concrete is concrete containing embedded steel bars, plates, or fibers that strengthen the concrete. Reinforced materials are embedded in the concrete in such a way that the two materials (i.e., reinforced materials and concrete) resist the applied forces together. The compressive strength of concrete and the tensile strength of, for example, steel form a strong bond to resist these stresses over a long span of time. The capability of reinforced concrete to carry loads is significantly increased in the tensile direction compared to conventional unreinforced concrete. Plain (unreinforced) concrete is not suitable for most construction projects because it cannot easily withstand the stresses created by vibrations, wind, or other forces. Accordingly, reinforced concrete has become the most commonly utilized construction material.

Reinforcing bar, also referred to as rebar, is an important component of reinforced concrete. Rebar is typically formed from ridged carbon steel, where the ridges give frictional adhesion to the concrete. Although concrete is very strong in compression, it is virtually without strength in tension. To compensate for the lack of strength, rebars are cast into concrete to carry the tensile loads on a structure.

Fiberglass reinforced polymer (FRP) rebar is a potentially useful rebar option. FRP rebar is a spiral-wrapped structural reinforcing rod made from a combination of fiberglass roving and resin. FRP rebar is suitable for any structural or architectural application where a material that is corrosion-resistant, lightweight, and non-conductive is required. Typically, FRP rebar is comprised of two elements: a fiber (e.g., carbon, glass, aramid, or basalt) and a resin (e.g., polyester, epoxy, or vinyl ester). The most common examples of FRP rebars are Glass Fiber Reinforced Polymer (GFRP) rebars and Carbon Fiber Reinforced Polymer (CFRP) rebars.

Composite rebars, such as GFRP and CFRP, tend to be brittle. High flexibility of rebar accommodates and absorbs concrete deformation resulting in longer durability of a structure. Accordingly, there exists a need for a rebar with immunity to corrosion, having high strength, high flexibility, and also is lightweight.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a fiber reinforced polymer rebar comprising a first composite of glass fibers distributed in a polymer matrix and a second composite of polyethylene terephthalate fibers distributed in the polymer matrix. The first composite forms an inner portion of the fiber reinforced polymer rebar, and the second composite forms an outer portion of the fiber reinforced polymer rebar.

In another aspect, the fiber reinforced polymer rebar is 30-70 vol. % of the first composite and 30-70 vol. % of the second composite.

In another aspect, the fiber reinforced polymer rebar is 20-40 vol. % of the polymer matrix, 30-40 vol. % of the glass fibers, and 30-40 vol. % of the polyethylene terephthalate fibers.

In another aspect, the first composite is bounded by the second composite.

In another aspect, the polymer matrix comprises a thermoset polymer or a thermoplastic polymer.

In another aspect, the polymer matrix comprises a vinyl ester resin, a polymethyl methacrylate, an epoxy resin, a polyurethane, or combinations thereof.

In another aspect, the first composite is a glass fiber reinforced vinyl ester composite, and the second composite is a polyethylene terephthalate fiber reinforced vinyl ester composite.

In another aspect, the polyethylene terephthalate fiber reinforced vinyl ester composite forms a protective barrier around the glass fiber reinforced vinyl ester composite.

In another aspect, one or more of the polyethylene terephthalate fibers is modified with functional chemicals to improve adhesion of the fiber reinforced polymer rebar to concrete.

In another aspect, the functional chemicals comprise one or more of mineral particles, pigments, and chemical additives.

In another aspect, a surface of the outer portion is non-abrasive.

In another aspect, the fiber reinforced polymer rebar is characterized by a Young's modulus value between approximately 30 GPa and approximately 35 GPa.

In another aspect, the glass fibers are distributed radially from a center of the fiber reinforced polymer rebar.

In one aspect, embodiments disclosed herein relate to a method of forming a fiber reinforced polymer rebar. Glass fibers and polyethylene terephthalate fibers are fed simultaneously into a resin impregnator to form a fiber mixture. The fiber mixture is pulled through a liquid polymeric resin in the resin impregnator to form a resin-soaked fiber mixture. The resin-soaked fiber mixture is passed through a heated stationary die, where resin of the resin-soaked fiber mixture undergoes polymerization and cross-linking to form the fiber reinforced polymer rebar.

In another aspect, feeding the glass fibers and the polyethylene terephthalate fibers comprises pulling the glass fibers and the polyethylene terephthalate fibers through fiber guiding plates.

In another aspect, the glass fibers and the polyethylene terephthalate fibers are pulled into the liquid polymeric resin.

In another aspect, a relative volume ratio of the glass fibers and the polyethylene terephthalate fibers is controlled.

In another aspect, a distribution of the glass fibers and the polyethylene terephthalate fibers across the fiber reinforced polymer rebar is controlled.

Other aspects and advantages of the claimed subject matter will be apparent from the following description and the appended claims.

### BRIEF DESCRIPTION OF DRAWINGS

FIG. 1 is an illustration of a highly flexible concrete reinforcement bar according to one or more embodiments of the present disclosure.

FIG. 2 is an illustration of a co-propulsion apparatus and process according to one or more embodiments of the present disclosure.

FIGS. 3A and 3B illustrate pre-form masks according to one or more embodiments of the present disclosure.

FIG. 4 illustrates concrete blocks according to one or more embodiments of the present disclosure.

FIG. 5 is an illustration of a highly flexible concrete reinforcement bar reinforced block according to one or more embodiments of the present disclosure.

FIG. 6 is a plot illustrating Young's modulus values of concrete versus time in days according to one or more embodiments of the present disclosure.

FIG. 7 illustrates equivalent stresses resulting from shrinkage on concrete blocks reinforced with different rebars according to one or more embodiments of the present disclosure.

FIG. 8 illustrates equivalent stresses resulting from thermal load on concrete blocks reinforced with different rebars according to one or more embodiments of the present disclosure.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

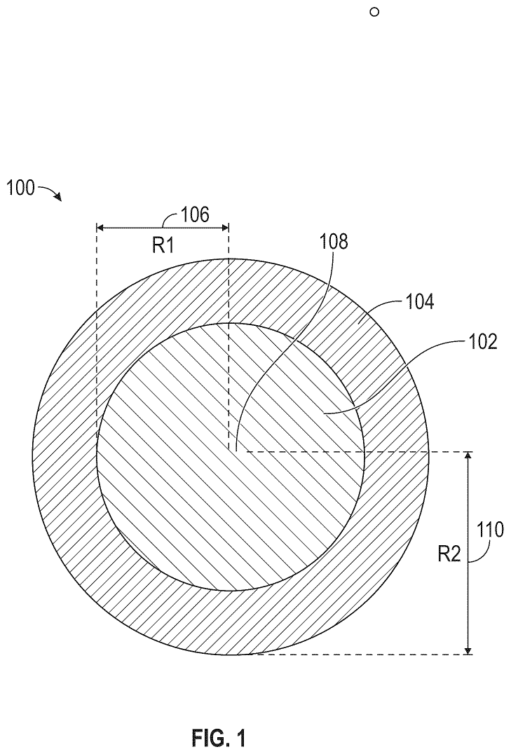

In the following description of FIGS. 1-8, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a passive soil gas sample system” includes reference to one or more of such systems.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

Embodiments of the present disclosure generally relate to a fiber reinforced polymer rebar composition with high flexibility and a method to manufacture the fiber reinforced polymer rebar for the reinforcement of concrete structures. The fiber reinforced polymer rebar composition is referred to herein as a highly flexible concrete reinforcing bar, or HFCRB, and improves durability of concrete structures.

In one or more embodiments, the highly flexible concrete reinforcing bar comprises a polymer matrix and at least two types of fibers: a first fiber and a second fiber. Each of the fiber types may be embedded within the polymer matrix and distributed in a particular pattern, or arrangement, throughout the polymer matrix during manufacturing to achieve a highly flexible concrete reinforcing bar having one or more desired characteristics.

In one or more embodiments, the polymer matrix of the highly flexible concrete reinforcing bar may be a thermoset polymer or a thermoplastic polymer. Non-limiting examples of thermosetting polymers that may be utilized include an epoxy resin, a vinyl ester resin, a polyester resin, and combinations thereof. For example, any one or more of the following commercial products may be utilized: Dion® Impact 9102-70 (e.g., epoxy-based vinyl ester resin) produced by Polynt Composites USA Inc. located at 99 East Cottage Avenue, Carpentersville, IL 60110; Crystic® 2-446PA Polyester Resin produced by Scott Bader, Inc. located at 212 Quality Drive, Mocksville, NC 27028; and polyurethane acrylate resin Crestapol® 1214 also produced by Scott Bader, Inc. Non-limiting examples of thermoplastic polymers include polymethyl methacrylate (PMMA) (e.g., Elium® resin produced by Arkema located at 900 First Avenue, King of Prussia, PA, 19406, USA) and polyamide 6 (e.g., carbon fiber reinforced PA6 rebar produced by SGL Composites Inc. located at 201 Technology Drive, Arkadelphia, AR, 71932, USA). Furthermore, the polymer matrix may be reinforced or modified with organic or mineral fillers. Examples of organic or mineral fillers include, but are not limited to, short fibers, clay particles, mineral particles, pigments, chemical additives, carbon black, elastomer inclusions, fire-retardant particles, ultraviolet (UV) stabilizers, and nanoparticles, such as graphene platelets or carbon nanotubes. Chemical additives may include chemicals for shrinkage control during protrusion, such as Sheet Molding Compound (SMC)/Bulk Molding Compound (BMC) (e.g., MODIPER® SV10A, a block copolymer of polyvinyl acetate-block-acid denaturized polystyrene copolymer, which may be obtained from NOF America Corporation located at One North Broadway, Suite 912, White Plains, NY 10601). In one or more embodiments, the chemical additive may be a fire retardant additive, such as Martinal® ON-313 S or Martinal® ON-906 based on Aluminum Trihydrate in a dosage of 50-100 Phr. Martinal® ON-313 S and Martinal® ON-906 may be obtained from Huber Advanced Materials located at 3100 Cumberland Blvd., Suite 600, Atlanta, GA, 30339.

In one or more embodiments, the polymer matrix may be included in the highly flexible concrete reinforcing bar in an amount ranging between about 20% to about 40% by volume, based on the total volume of the highly flexible concrete reinforcing bar. The polymer may be included in the highly flexible concrete reinforcing bar in an amount having a lower limit of any of 15 vol. %, 16 vol. %, 17 vol. %, 18 vol. %, 19 vol. %, 20 vol. %, 21 vol. %, 22 vol. %, 23 vol. %, 24 vol. %, 25 vol. %, 26 vol. %, 27 vol. %, 28 vol. %, 29 vol. %, 30 vol. %, 31 vol. %, 32 vol. %, 33 vol. %, 34 vol. %, 35 vol. %, 36 vol. %, 37 vol. %, 38 vol. %, 39 vol. %, 40 vol. %, 41 vol. %, 42 vol. %, 43 vol. %, and 44 vol. % to an upper limit of any of 16 vol. %, 17 vol. %, 18 vol. %, 19 vol. %, 20 vol. %, 21 vol. %, 22 vol. %, 23 vol. %, 24 vol. %, 25 vol. %, 26 vol. %, 27 vol. %, 28 vol. %, 29 vol. %, 30 vol. %, 31 vol. %, 32 vol. %, 33 vol. %, 34 vol. %, 35 vol. %, 36 vol. %, 37 vol. %, 38 vol. %, 39 vol. %, 40 vol. %, 41 vol. %, 42 vol. %, 43 vol. %, 44 vol. %, and 45 vol. % based on the total volume of the highly flexible concrete reinforcing bar, where any lower limit can be used in combination with any upper limit.

In one or more embodiments, the polymer may be a vinyl ester-based polymer having a Young's modulus ranging from between about 1500 MPa to about 4000 MPa when tested according to ISO 527. The Young's modulus of the vinyl ester-based polymer may have a lower limit of any of 1500 MPa, 1600 MPa, 1700 MPa, 1800 MPa, 1900 MPa, 2000 MPa, 2100 MPa, 2200 MPa, 2300 MPa, 2400 MPa, 2500 MPa, 2600 MPa, 2700 MPa, 2800 MPa, and 2900 MPa, and an upper limit of any of 3000 MPa, 3100 MPa, 3200 MPa, 3300 MPa, and 3400 MPa, 3500 MPa, 3600 MPa, 3700 MPa, 3800 MPa, 3900 MPa, or 4000 MPa, where any lower limit may be paired to any mathematically compatible upper limit.

In one or more embodiments, the polymer may be a vinyl ester-based polymer with a strain at failure ranging from between about 2% to about 15% when assessed according to ISO 527. The strain at failure of the vinyl ester-based polymer may have a lower limit of any of 2.0%, 2.5%, 3.0%, 3.5%, 4.0%, 4.5%, 5.0%, 5.5%, 6.0%, 6.5%, and 7.0% and an upper limit of any of 7.5%, 8.0%, 8.5%, 9.0%, 9.5%, 10%, 10.5%, 11.0%, 11.5%, 12.0%, 12.5%, 13.0%, 13.5%, 14.0%, 14.5% and 15.0%, where any lower limit may be paired to any mathematically compatible upper limit.

In one or more embodiments, the polymer may be a vinyl ester-based polymer with a stress at failure ranging from between about 50 MPa to about 100 MPa when assessed according to ASTM D638. The stress at failure of the vinyl ester-based polymer may have a lower limit of any of 50 MPa, 55 MPa, 60 MPa, 65 MPa, and 70 MPa and an upper limit of any of 75 MPa, 80 MPa, 85 MPa, 90 MPa, 95 MPa, and 100 MPa, where any lower limit may be paired to any mathematically compatible upper limit.

In one or more embodiments, the polymer may be a vinyl ester-based polymer with a density ranging from between about 1,000 kg/m3 to about 1,200 kg/m3 when measured according to ASTM D1505-18. The density may be in an amount having a lower limit of any of 1,020 kg/m³, 1,040 kg/m³, 1,060 kg/m³, 1,080 kg/m³, and 1,100 kg/m³ to an upper limit of any of 1,110 kg/m³, 1,120 kg/m³, 1,140 kg/m³, 1,160 kg/m³, 1,180 kg/m³, and 1,200 kg/m³, where any lower limit may be paired to any mathematically compatible upper limit.

In one or more embodiments, the first fiber is a glass fiber. In one or more embodiments, the first fiber may be included in the highly flexible concrete reinforcing bar in an amount ranging between about 30% to about 40% by volume, based on the total volume of the highly flexible concrete reinforcing bar. The glass fibers may be included in the highly flexible concrete reinforcing bar in an amount having a lower limit of any of 30 vol. %, 31 vol. %, 32 vol. %, 33 vol. %, 34 vol. %, 35 vol. %, 36 vol. %, 37 vol. %, 38 vol. and 39 vol. %, to an upper limit of any of 31 vol. %, 32 vol. %, 33 vol. %, 34 vol. %, 35 vol. %, 36 vol. %, 37 vol. %, 38 vol. %, 39 vol. %, and 40 vol. %, based on the total volume of the highly flexible concrete reinforcing bar, where any lower limit can be used in combination with any upper limit. The glass fiber may be S-glass, E-glass, ECR-glass, H-glass, or any other type of glass fiber known in the art.

In one or more embodiments, the first fiber may be selected from glass fibers with a diameter ranging from between about 5 μm to about 25 μm. The diameter may be in an amount having a lower limit of any of 5 μm, 6 μm, 7 μm, 8 μm, 9 μm, 10 μm, 11 μm, and 12 μm, to an upper limit of any of 13 μm, 14 μm, 15 μm, 16 μm, 17 μm, 18 μm, 19 μm, 20 μm, 21 μm, 22 μm, 23 μm, 24 μm and 25 μm, where any lower limit may be paired to any mathematically compatible upper limit.

In one or more embodiments, the second fiber is a polyester fiber, such as polyethylene terephthalate (PET). In one or more embodiments, the second fiber may be selected from PET fibers with a Young's modulus ranging from between about 6,000 MPa to about 29,000 MPa when evaluated according to ASTM D3822M-14. The Young's modulus may be in an amount having a lower limit of any of 6,000 MPa, 7,000 MPa, 8,000 MPa, 9,000 MPa, 10,000 MPa, 11,000 MPa, 12,000 MPa, 13,000 MPa, 14,000 MPa, and 15,000 MPa, 16,000 MPa, 17,000 MPa, 18,000 MPa, 19,000 MPa, and 20,000 MPa, 21,000 MPa, 22,000 MPa, 23,000 MPa, 24,000 MPa, 25,000 MPa, 26,000 MPa, 27,000 MPa, and 28,000 MPa to an upper limit of any of 7,000 MPa, 8,000 MPa, 9,000 MPa, 10,000 MPa, 11,000 MPa, 12,000 MPa, 13,000 MPa, 14,000 MPa, 15,000 MPa, 16,000 MPa, 17,000 MPa, 18,000 MPa, 19,000 MPa, 20,000 MPa, 21,000 MPa, 22,000 MPa, 23,000 MPa, 24,000 MPa, 25,000 MPa, 26,000 MPa, 27,000 MPa, 28,000 MPa, and 29,000 MPa where any lower limit may be paired to any mathematically compatible upper limit.

In one or more embodiments, the second fiber may be selected from PET fibers with a strength at failure ranging from between about 500 MPa to about 900 MPa when evaluated according to ASTM D3822M-14. The strength at failure may be in an amount having a lower limit of any of 500 MPa, 550 MPa, 600 MPa, 650 MPa, 700 MPa, 750 MPa, 800 MPa, and 850 MPa, to an upper limit of any of 550 MPa, 600 MPa, 650 MPa, 700 MPa, 750 MPa, 800 MPa, 850 MPa, and 900 MPa, where any lower limit may be paired to any mathematically compatible upper limit.

In one or more embodiments, the second fiber may be selected from PET fibers with a density ranging from between about 1,000 kg/m³ to about 1,500 kg/m³ when evaluated according to ASTM D3800-16. The density may be in an amount having a lower limit of any of 1,000 kg/m³, 1,050 kg/m³, 1,100 kg/m³, 1,150 kg/m³, 1,200 kg/m³, and 1,250 kg/m³, to an upper limit of any of 1,300 kg/m³, 1,350 kg/m³, 1,400 kg/m³, 1,450 kg/m³, and 1,500 kg/m³ where any lower limit may be paired to any mathematically compatible upper limit.

In one or more embodiments, the second fiber may be selected from PET fibers with a diameter ranging from between about 3 μm to about 15 μm. The diameter may be in an amount having a lower limit of any of 3 μm, 4 μm, 5 μm, 6 μm, 7 μm, 8 μm, 9 μm, and 10 μm, to an upper limit of any of 11 μm, 12 μm, 13 μm, 14 μm, and 15 μm, where any lower limit may be paired to any mathematically compatible upper limit. It should be recognized by one skilled in the art that although glass and PET fibers may be used, other fibers with similar physical and chemical properties may be used in place of each of those, such as other polyester fibers similar to PET.

In one or more embodiments, the PET fibers may be included in the highly flexible concrete reinforcing bar in an amount ranging between about 30% to about 40% by volume, based on the total volume of the highly flexible concrete reinforcing bar. The PET fibers may be included in the highly flexible concrete reinforcing bar in an amount having a lower limit of any of 30 vol. %, 31 vol. %, 32 vol. %, 33 vol. %, 34 vol. %, 35 vol. %, 36 vol. %, 37 vol. %, 38 vol. %, and 39 vol. %, to an upper limit of any of 31 vol. %, 32 vol. %, 33 vol. %, 34 vol. %, 35 vol. %, 36 vol. %, 37 vol. %, 38 vol. %, 39 vol. %, and 40 vol. %, based on the total volume of the highly flexible concrete reinforcing bar, where any lower limit can be used in combination with any upper limit.

FIG. 1 illustrates a cross-sectional view of a highly flexible concrete reinforcing bar 100 according to the present disclosure. In one or more embodiments, the highly flexible concrete reinforcing bar 100 comprises an inner portion 102 and an outer portion 104 surrounding the inner portion 102, such that the inner portion is bounded by the outer portion 104. The inner portion 102 may comprise a polymer matrix having the first fiber embedded therein, and the outer portion 104 may comprise a polymer matrix having the second fiber embedded therein. The inner portion 102 may be comprised of a composite of glass fiber and polymer matrix, and the outer portion 104 may be comprised of a composite of PET fiber and polymer matrix. In one or more embodiments, the polymer matrix is a vinyl ester resin. The ASTM D7957 requires a composite rebar to contain at least 70% fiber by weight. Table 5 presented below shows that the highly flexible concrete reinforcing bar according to one or more embodiments of the present disclosure provides a 78% fiber by weight of the rebar. Provided that the fibers' density remains higher than the resins' density and adopting a maximum packing of fiber in the rebar, the 70% rule is met.

In one or more embodiments, the outer portion 104, or periphery, is a PET fiber reinforced vinyl ester composite, and the inner portion 102, or core, is a glass fiber reinforced vinyl ester composite. The highly flexible concrete reinforcing bar composition may be comprised of an amount of the PET fiber reinforced vinyl ester composite and an amount of the glass fiber reinforced vinyl ester composite. The amounts of each material may be equivalent or may vary from one another.

In one or more embodiments, the amount of the PET fiber reinforced vinyl ester composite in the highly flexible concrete reinforcing bar composition is an amount ranging from 30-70% by volume of the highly flexible concrete reinforcing bar composition, such as between 40-60% by volume of the highly flexible concrete reinforcing bar composition, such as between 45-55% by volume of the highly flexible concrete reinforcing bar composition, such as 50% by volume of the highly flexible concrete reinforcing bar composition.

In one or more embodiments, the amount of the glass fiber reinforced vinyl ester composite in the highly flexible concrete reinforcing bar composition is an amount ranging from 30-70% by volume of the highly flexible concrete reinforcing bar composition, such as between 40-60% by volume of the highly flexible concrete reinforcing bar composition, such as between 45-55% by volume of the highly flexible concrete reinforcing bar composition, such as 50% by volume of the highly flexible concrete reinforcing bar composition.

In one or more embodiments, the total volume of the highly flexible concrete reinforcing bar composition is equal to the combined volumes of the PET fiber reinforced vinyl ester composite and the glass fiber reinforced vinyl ester composite. The replacement of about a volume of glass fiber with PET fiber in the highly flexible concrete reinforcing bar provides an advantage to the highly flexible concrete reinforcing bar compared to conventional GFRP rebar in terms of embodied energy, CO₂ footprint and water usage, as illustrated in Table 1.

TABLE 1
CO₂ Footprint and Embodied Energy Per
Components of the GFRP Rebar and HFCRB

| | Embodied | CO2 | | | |
|---|---|---|---|---|---|
| | energy | footprint | | Weight in | Weight in |
| | (production + | (production + | Water | GFRP (1 m | HFCRB (1 m |
| | processing) | processing) | usage | of 10 mm | of 10 mm |
| | MJ/kg | kg/kg | l/kg | diam.) | diam.) |
| PET fiber | 85 + 18 | 3.9 + 0.61 | 30 | 0 | 35.2 |
| E-Glass | 65.5 + 2.6 | 3.5 + 0.2 | 94 | 131.2 | 67.4 |
| fiber | | | | | |
| Epoxy- | 139 | 6.7 | 214 | 28.8 (standard | 29.3 (DION |
| based | | | | epoxy) | vinyl-ester) |
| vinyl-ester | | | | | |

Table 2 below shows environmental indicators for components of the highly flexible concrete reinforcing bar (HFCRB). Table 3 shows the same environmental indicators for components of glass fiber reinforced polymer (GFRP).

TABLE 2
HFCRB Detailed Results

| | | Vinyl | | | | | | | | |
|---|---|---|---|---|---|---|---|---|---|---|
| Environmental | | ester | Glass | PET | | Inbound | | End -of- | Waste* | |
| Indicators | Unit | resin | fibers | fibers | Electricity | Transport | Dispatch | Life | (Credit) | Total |
| CML2001 - | kg | 12.76 | 14.20 | 9.76 | 8.59 | 1.06 | 0.09 | 0.05 | −0.001 | 46.50 |
| August | CO₂ | | | | | | | | | |
| 2016, | eq. | | | | | | | | | |
| GWP | | | | | | | | | | |
| Primary | MJ | 285.56 | 206.61 | 288.10 | 128.80 | 15.74 | 1.31 | 0.53 | −0.02 | 926.64 |
| energy | | | | | | | | | | |
| demand | | | | | | | | | | |

TABLE 3
GFRP Detailed Results

| | | Vinyl | | | | | | | |
|---|---|---|---|---|---|---|---|---|---|
| Environmental | | ester | Glass | | Inbound | | End -of- | Waste* | |
| Indicators | Unit | resin | fibers | Electricity | Transport | Dispatch | Life | (Credit) | Total |
| CML2001 - | kg | 12.63 | 29.99 | 11.33 | 1.51 | 0.12 | 0.06 | −0.001 | 55.63 |
| August | CO₂ | | | | | | | | |
| 2016, | eq. | | | | | | | | |
| GWP | | | | | | | | | |
| Primary | MJ | 282.61 | 436.21 | 169.96 | 22.49 | 1.73 | 0.70 | −0.021 | 913.68 |
| energy | | | | | | | | | |
| demand | | | | | | | | | |

The PET-vinyl ester composite of the outer portion 104 may constitute a chemical barrier that provides protection of the glass fibers in the inner portion 102 against hydroxyl ions present in the concrete, such as are present in pore hydrated Portland cement mix. A chemical attack of this type may lead to hydroxylation of glass fibers and, ultimately, loss of mechanical properties. The barrier effect provided by the highly flexible concrete reinforcing bar composition may allow for the utilization of more cost-effective glass fibers (i.e., less corrosion resistant fibers), such as untreated glass fibers (i.e., E-glass rather than glass).

The tensile Young's modulus of the highly flexible concrete reinforcing bar according to one or more embodiments of the present disclosure may be reduced to a minimum value allowed by construction standards, which is close to concrete stiffness. For example, the Young's modulus value of the highly flexible concrete reinforcing bar may be between 30 GPa and 35 GPa. The Young's modulus value is achieved by replacing 50% by volume of glass fiber (70 GPa Young's modulus) with high tenacity PET fibers (6.6 GPa (6,600 MPa) Young's modulus). The typical Young's modulus value of concrete is between 25 GPa and 35 GPa according to Canadian Standard Association CSA S807.

In one or more embodiments, the PET fibers may be functionalized to provide a chemical option for the adhesion of the rebar to concrete. For example, PET fiber may be functionalized by creating carboxylic groups at the fiber surface. Functionalization may be performed by passing the fiber strand through a 50:50 by volume solution of acetic acid and formaldehyde for approximately 10 minutes and drying the fiber strand by passing it through a heat oven at 45° C. for approximately three to five minutes. The fiber strands may then be passed through a second solution of 50:50 by volume of sodium hydroxide and bromoacetic acid for an additional 15 minutes and drying at room temperature. Additional materials for PET fiber functionalization may include AgCl nanoparticles, triethylenetetramine (TETA), tetraethylenepentamine (TEPA), ethylenediamine, polyethylene glycol, and sodium dodecyl sulphate. The surface of the PET fibers may also be treated by ozone treatment, ultraviolet (UV) radiation, or ultrasonic treatment. Furthermore, the PET fiber surface may be coated with a resorcinol-formaldehyde-latex coupling agent or silanol groups.

In one or more embodiments, adhesion between the resin binder and the PET/glass fiber is improved by adding a wetting and dispersing additive, such as BYK-W 996 produced by BYK USA located at 524 South Cherry St., Wallingford, CT 06492. The BYK-W-996 powder may be mixed at a dosage from 0.5 to 2% by weight with the liquid resin prior to passing the PET/glass fiber through the pultrusion bath. This approach of functionalization and use of a wetting/dispersing agent may be used together or separately.

In one or more embodiments, the highly flexible concrete reinforcing bar 100 is a substantially cylindrical, elongated member having a first circular end, a second circular end, and a length extending between the first end and the second end. A first radius 106 (R₁) is measured from a center 108 of the highly flexible concrete reinforcing bar 100 to an outer edge of the inner portion 102 of the highly flexible concrete reinforcing bar 100. A second radius 110 (R₂) is measured from the center 108 to an outer edge of the outer portion 104. In one or more embodiments, the first radius 106 (R₁) has a value that is less that the value of the second radius 110 (R₂). As can be appreciated by one skilled in the art, the arrangement of materials depicted in FIG. 1 is not intended to limit the highly flexible concrete reinforcing bar described herein to the particular materials, arrangement, or amounts shown.

### Theory

To achieve equal volumetric fractions, R₁ (first radius) and R₂ (second radius) must satisfy the following relation:

R₁=\sqrt{0.5}×R₂.

The deflection of a beam is driven by the following equation:

$$\partial = \frac{F \times {l}^{3}}{3 E I} ,$$

where F is the force applied perpendicularly to the beam, l is the length of the beam, E is the Young's modulus of the material's beam, and I is the area moment of the beam. Flexural stiffness k of the beam is calculated as follows:

$$k = \frac{3 E I}{{l}^{3}} .$$

The moment of inertia of a disc with respect to a symmetry axis is expressed as:

$$I = \frac{π}{4} \times {R}^{4} .$$

The moment of inertia of a hollow disc with respect to a symmetry axis is expressed as:

$$I = \frac{π}{4} \times ( {R}_{2}^{4} - {R}_{1}^{4} ) .$$

In the case of a cylindrical bi-material beam, the product E.I is calculated as follows:

$$E . I = \frac{π}{4} \times ( {R}_{1}^{4} ( {E}_{1} - {E}_{2} ) + {E}_{2} {R}_{2}^{4} ) .$$

### Material Properties

Table 4 lists the properties of the materials used in various exemplary compositions according to one or more embodiments of the present disclosure.

TABLE 4

| | | | | Ultimate | Strain |
|---|---|---|---|---|---|
| | | Density | Young's | tensile | at |
| | Commercial | (ton · | modulus | strength | failure |
| Material | grade | m⁻³) | (MPa) | (MPa) | (%) |
| Thermoset | Polynt Dion | 1.07 | 3,200 | 85 | 2.0 |
| matrix used in | IMPACT | | | | |
| HFCRB | 9102-70 | | | | |
| Thermoset | Polynt Dion | 1.05 | 3,200 | 85 | 2.0 |
| matrix used in | IMPACT | | | | |
| HFCRB | 9102-70 | | | | |
| Glass Fiber | Jushi E-6 | 2.55 | 70,000 | 1,500 | 1.4 |
| PET fiber | Barnet | 1.38 | 6,600 | 850 | 10-12 |
| | HCDK040 | | | | |

### Manufacturing Process

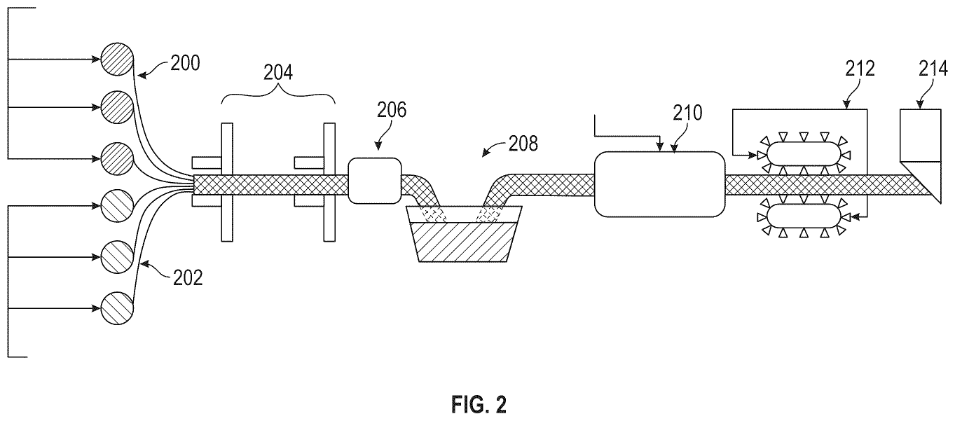

The manufacturing process used to manufacture the highly flexible concrete reinforcing bar described herein is a variant of pultrusion, called co-pultrusion, which consists of pultruding two different fibers simultaneously and integrating them in the same structure. FIG. 2 is a schematic illustration of a co-pultrusion apparatus and process according to embodiments of the present disclosure. In one or more embodiments, the first step in the co-pultrusion process may include feeding a first fiber 200 and a second fiber 202 through fiber guiding plates 204. The arrangement of fibers in the highly flexible concrete reinforcing bar may be controlled by the fiber guiding plates 204. The fiber guiding plates 204 may have a series of holes through which different fibers are fed. Different fibers may be fed through different holes to achieve a desired distribution of fibers in the highly flexible concrete reinforcing bar. Thus, the configuration of holes in the fiber guiding plates 204 determines the arrangement of fibers in the highly flexible concrete reinforcing bar.

The temperature range at which the fibers are pulled through the fiber guiding plates 204 may be in the range of between 30° C. to about 45° C. The temperature may have a lower limit of any of 30° C., 31° C., 32° C., 33° C., 34° C., 35° C., 36° C., and 37° C., to an upper limit of any of 38° C., 39° C., 40° C., 41° C., 42° C., 43° C., 44° C., and 45° C., where any lower limit may be paired to any mathematically compatible upper limit. The temperature may be maintained using infrared heaters.

The first and second fibers 200 and 202 may be passed through an atmospheric plasma treatment chamber 206 prior to being fed to a resin impregnator 208. Atmospheric plasma treatment is a known surface treatment technique that uses compressed air to clean and activate materials, thereby facilitating bonding of adhesives, coatings, epoxies, and resins. The first and second fibers 200 and 202 may be fed to the resin impregnator 208, forming a fiber mixture. The fiber mixture may be pulled through a liquid polymer resin in the resin impregnator 208 to form a resin-soaked fiber mixture. The resin-soaked fiber mixture may be polymerized and/or cured by passing it through a heated stationary die 210 at a specific temperature based. The polymerization and/or curing temperature may be determined by whether the polymer resin is a thermoset or thermoplastic and the specific polymerization/curing requirements for the given polymer resin. The resin of the resin-soaked fiber mixture undergoes polymerization and/or cross-linking to form the highly flexible concrete reinforcing bar. In one or more embodiments, the shape of the opening in the heated stationery die 210 may be circular with a diameter of, for instance, about 10 mm. However, in other embodiments, different sized openings can be used to produce different diameter rebars. The length of the heated stationary die 210 in one or more embodiments may vary, and may be up to one meter. To remove the rebar from the heated stationary die 210, a pulling mechanism with pullers 212 pulls the rebar out of the heated stationary die 210. Once removed, cutters 214 cut the formed rebar into appropriate lengths.

In one or more embodiments, the two fibers may be pulled simultaneously at a speed of between 0.1 to 0.3 meters/minute. In one or more embodiments, the pulling speed is about twelve inches per minute. As may be appreciated by those skilled it the art, the speed may be adjusted as required to avoid problems such as fibers buckling in the process. The pulling speed is generally a compromise between rebar quality and production rate. The temperature of the heated stationary die may be adjusted to obtain a minimum of 95% curing of the polymer matrix according to ASTM D7957. In one or more embodiments, the heated stationary die temperature is in a range of about 150-350° F.

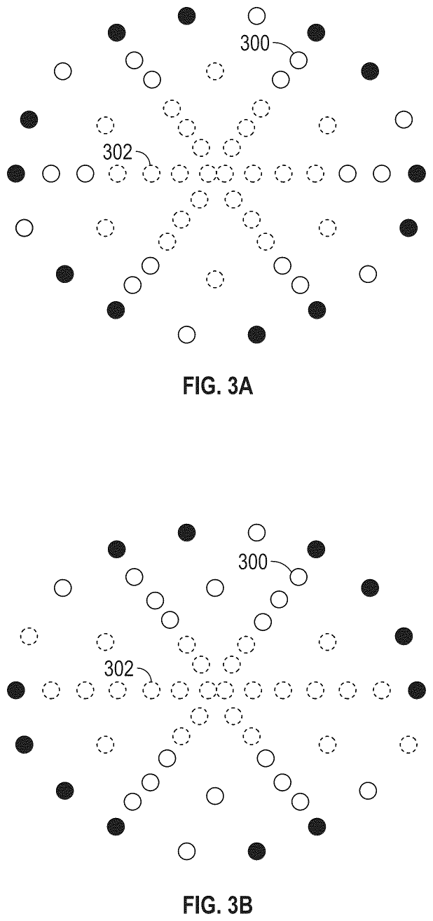

Non-limiting examples of fiber guiding plates (also referred to as pre-form masks or templates) used to design the highly flexible concrete reinforcing bar are presented in FIGS. 3A and 3B. Solid circles (e.g., 300) denote where PET fiber may be inserted, and dashed circles (e.g., 302) denote where glass fiber may be inserted. FIG. 3A depicts a fiber guiding plate where the glass fibers are distributed radially from a center of the highly flexible concrete reinforcing bar. FIG. 3B illustrates a fiber guiding plate for a variant highly flexible concrete reinforcing bar, where different fiber distribution may lead to reduced flexibility only in the vertical direction due to glass fiber (e.g., 302) that occupies the middle horizontal layer of the rebar. Using the fiber guiding plates, a local orientation of the glass fibers and the PET fibers relative to a longitudinal direction of the highly flexible concrete reinforcing bar may be controlled. Thus, a relative volume ratio of the glass fibers and the PET fibers may be controlled. A benefit of the described co-pultrusion process is the ability to control the distribution of the two fibers within and across the highly flexible concrete reinforcing bar to optimize the load distribution.

### Mechanical Properties

The weight, flexural stiffness, and tensile modulus for the highly flexible concrete reinforcing bar and standard GFRP rebar are presented in Table 5 below.

TABLE 5
Compared Performance for the HFCRB and Standard GFRP Rebar

| | | HFCR bar (40% vol. glass | |
|---|---|---|---|
| | GFRP rebar | fiber; 32% vol. PET fiber) | Unit |
| Fiber weight percentage (ASTM | 82% | 78% | (—) |
| D7957) | | | |
| Weight (13 mm diameter) | 292 ** | 232 ** | g/m |
| E.I (13 mm diameter) | 77.1 ** | 24 ** | Pa · m⁴ |
| Rebar flexural stiffness (13 mm | 231 ** | 72 ** | N/m |
| diameter) | | | |
| Rebar tensile modulus (13 mm | 57.79 e+09 *** | 34.65 ± 0.8 * | Pa |
| diameter) | | | |
| Rebar tensile strength (13 mm | 800-1100 *** | 815.33 ± 17.0 * | MPa |
| diameter) | | | |
| Rebar tensile strength (10 mm | 1150 ± 34 * | NA | MPa |
| diameter) | | | |

* measured;
** numerically or analytically estimated;
*** supplier data

### Finite Element Analyses

Finite element analyses were conducted to assess the behavior of the highly flexible concrete reinforcing bar in concrete structures. The numerical analyses were used to illustrate the qualitative advantages of using the highly flexible concrete reinforcing bar. The composite rebar described herein combines high flexibility with a Young's modulus in the axial direction close to the Young's modulus of concrete. The flexibility of the highly flexible concrete reinforcing bar accommodates and absorbs concrete deformation in the case of anisotropic structural deformation. The Young's modulus characteristic allows the concrete to transfer deformation to the rebar, which is more deformable and ductile than concrete. A direct consequence of this combination of materials is a more durable adhesion between rebar and concrete and, thus, a longer durability of the structure.

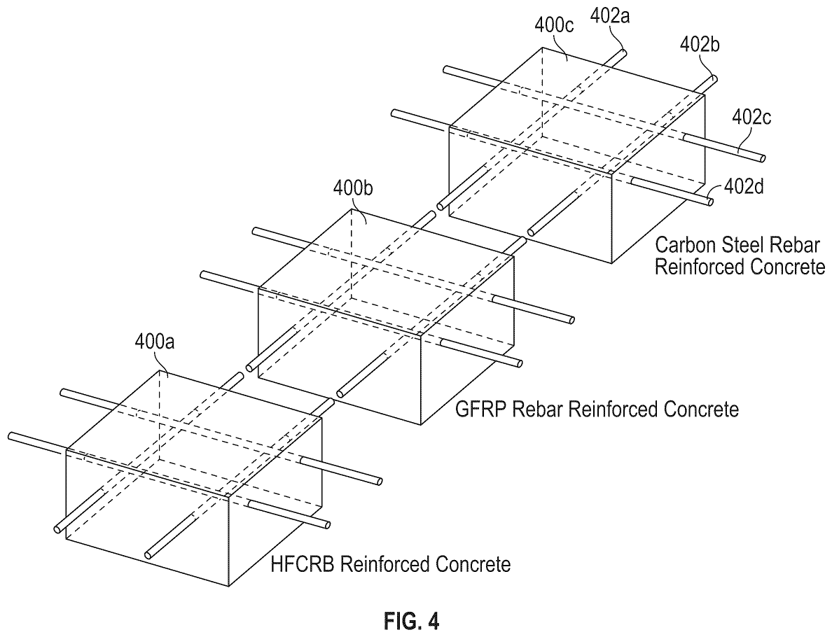

Properties of concrete blocks reinforced with highly flexible concrete reinforcing bar, carbon steel, or GFRP were modeled. FIG. 4 illustrates three-dimensional concrete blocks: HFCRB reinforced concrete block 400a, GFRP rebar reinforced concrete block 400b, and carbon steel rebar reinforced concrete block 400c. Each concrete block was reinforced with four rebars (e.g., 402a, 402b, 402c, and 402d) that are positioned in both plane directions with two rebars in each plane direction. Each block 400a, 400b, and 400c comprises only one type of rebar. Each rebar had the same diameter (e.g., 13 millimeters (mm)). The spacing between each rebar was set to 200 mm. The base of each concrete block 400a, 400b, and 400c was fixed in all directions to represent the adhesive support from a lean concrete base. All five other block faces were free to move. All rebars were bonded to the concrete matrix and were free to move in all directions. A gravity field was added that corresponded to an acceleration of 10 m·s⁻².

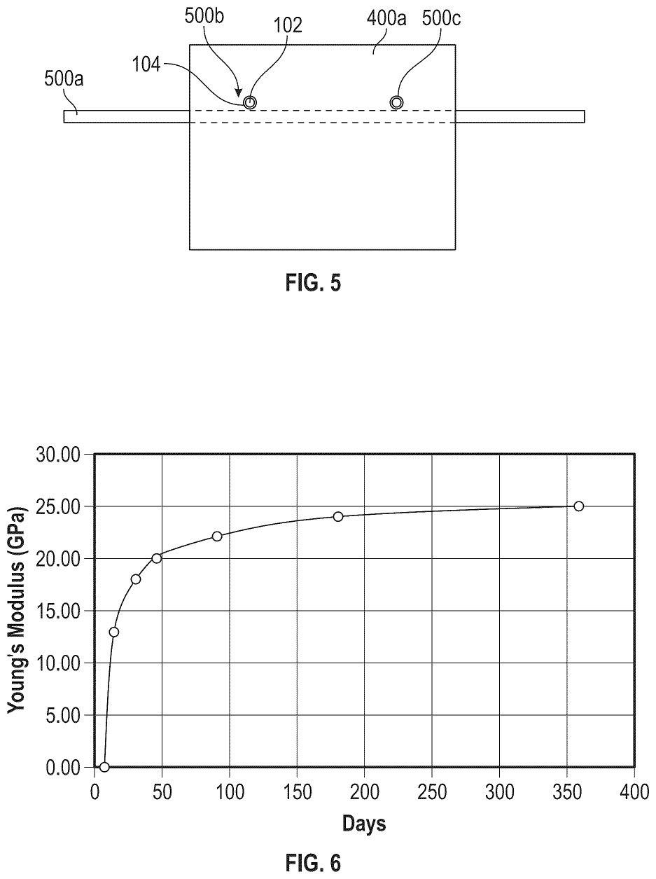

FIG. 5 is a side-view illustration of a highly flexible concrete reinforcing bar reinforced block 400a, reinforced with four rebars although only three highly flexible concrete reinforcing bar rebars 500a, 500b, and 500c are depicted in this view, including a cross-sectional view of two highly flexible concrete reinforcing bar rebars 500b and 500c. In the embodiment shown, the inner portion 102, or core, of the highly flexible concrete reinforcing bar is composed of GFRP composite, and the outer portion 104, or periphery, is composed of PET-vinyl-ester composite, as described in detail above.

The material properties of concrete include a density of 2.4 ton/m³, a thermal expansion (isotropic) of 1e-05 C⁻¹, and shrinkage of 0.07% over 360 days. FIG. 6 shows Young's modulus values of concrete versus time in days. The time dependence of concrete's Young's modulus allows reproduction of the empirical observation that 30% of total shrinkage occurs approximately during the first and second weeks following installation.

Table 6 below lists the main thermomechanical properties of carbon steel, GFRP composite, and PET-vinyl-ester composite. The Young's modulus and thermal expansion of the PET-vinyl-ester composite were numerically assessed via Digitmat® software.

TABLE 6

| | | Young's | Young's | Thermal | Thermal |
|---|---|---|---|---|---|
| | Density | modulus | modulus | expansion | expansion |
| | (ton/m³) | (axial) (Pa) | (radial) (Pa) | (axial) | (radial) |
| Carbon Steel | 7.8 | 2.0e+11 Pa | | 1.2e−05 C⁻¹ | |
| GFRP | 2.2 | 5.8e+10 Pa | 9.0e+09 Pa | 6.0e−06 °C^{-1[1]} | 2.2e−05 C^{-1[1]} |
| PET-Vinyl- | 1.24 | 4.5e+09 Pa * | | 6.6e−05 C⁻¹ * | |
| ester | | | | | |

* numerically assessed via Digimat ® software

### Example #1: Performance During Concrete Shrinkage

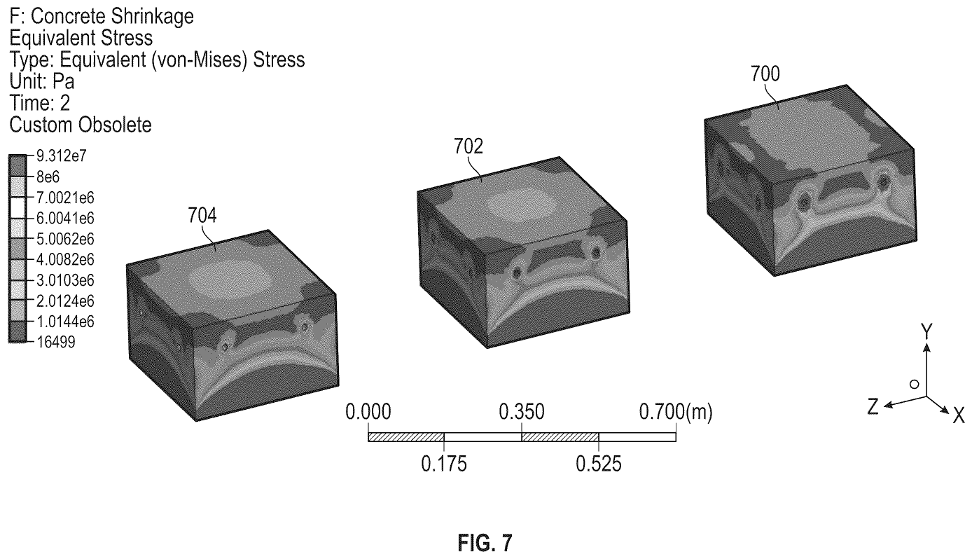

A homogenous isotropic shrinkage of 0.07% was imposed to the volume of concrete which, combined with the acceleration field, generated a stress distribution in the concrete volume. Isotropic shrinkage is a measure of how much the volume of concrete shrinks overall, which is the same in all directions. The isotopic shrinkage was calculated by estimating the shrinkage in the perpendicular and parallel directions. FIG. 7 illustrates equivalent stresses resulting from shrinkage, plotted on the concrete blocks reinforced with carbon steel rebar 700, GFRP rebar 702, and highly flexible concrete reinforcing bar 704. It was observed that equivalent stresses, as well as principal maximum stresses, in the vicinity of the carbon steel rebar 700 and the GFRP rebar 702 exceeded 8 MPa, which is significant. This suggests that concrete shrinkage may deteriorate the load transfer between concrete and reinforcement in the case of low-flexibility reinforcements, particularly when the level of stress is tensile stress. In contrast, the highly flexible concrete reinforcing bar 704 described herein showed lower stress concentration at the concrete/rebar interface, suggesting the load transfer between concrete matrix and reinforcement is more likely to persist following concrete shrinkage. The level of stresses at the top surface of the highly flexible concrete reinforcing bar 704 reinforced concrete blocks increased compared to the GFRP rebar 702 and the carbon steel rebar 700 reinforced concrete blocks, suggesting a higher cracks probability. However, higher crack density or greater width of cracks is less critical with composite rebars than with steel rebar, as composite rebars are not susceptible to corrosion.

### Example #2: Performance During Concrete Shrinkage

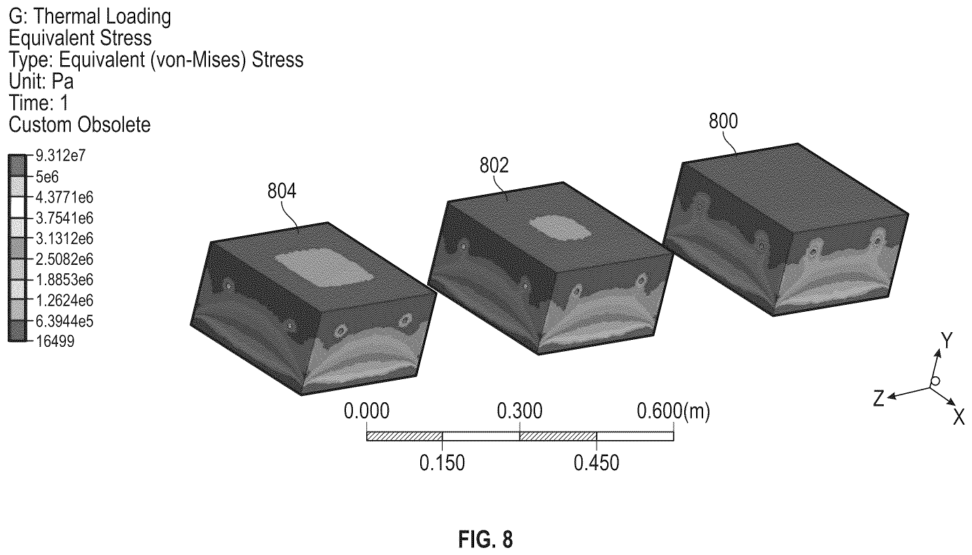

Blocks of reinforced concrete were subjected to a decrease of temperature from ambient temperature (approximately 20° C.) to approximately 3° C. FIG. 8 shows equivalent stresses resulting from thermal load plotted on concrete blocks reinforced with carbon steel rebar 800, GFRP rebar 802, and highly flexible concrete reinforcing bar 804. Similar to the shrinkage analysis, stresses in concrete at the vicinity of the concrete block reinforced with the highly flexible concrete reinforcing bar 804 are lower compared to the concrete blocks reinforced with the GFRP rebar 802 and the carbon steel rebar 800.

Loss of load bearing capacity (i.e., capacity of stresses to transfer from the concrete matrix to the reinforcement) in reinforced concrete structures due to differential thermomechanical properties between concrete and reinforcement and leading to debonding between the reinforcement (steel or GFRP rebar) and the concrete matrix is an existing problem in the field. Concrete shrinkage typically occurs during the first months of concrete drying, leading to cracking and loss of load-bearing capacity attributed to a lack of deformability of the reinforcement. Thermal expansion differential between concrete and rebar during thermal cycles also leads to a cracking and loss of load-bearing capacity due to the lack of deformability of the reinforcement. The highly flexible concrete reinforcing bar described herein addresses these problems because the three-phase composite rebar is designed in such a way that key mechanical properties are finely adjusted to be close to key mechanical properties of the concrete matrix.

As described above, the Young's modulus of the highly flexible concrete reinforcing bar is close to that of concrete. The flexural Young's modulus of the highly flexible concrete reinforcing bar is lowered to give the rebar the capability to absorb a maximum of deformation incurred by the concrete matrix due to its isotropic or anisotropic shrinkage and thermo-mechanical load cycles. The characteristic is achieved by distributing PET fibers in a specific pattern within the structure of the composite rebar. The distribution of the PET fibers is achieved during manufacturing by positioning glass fibers at the core of the rebar and positioning PET fibers at the outside of the composite rebar. The resulting internal structure allows for a decrease in the product of Young's modulus by moment of inertia of the composite rebar, thereby significantly decreasing flexural Young's modulus.

In addition to those described above, embodiments of the present disclosure may provide at least one of the following advantages. The highly flexible concrete reinforcing bar described herein combines a core-periphery structure with rarely combined materials to address shrinkage-originated cracking and rebar-concrete debonding. Due to the low fracture toughness of the PET-vinyl-ester composite material disposed at the periphery of the rebar, machining of helical grooves for rebar/concrete interlocking may be simplified. As described above, the PET-vinyl-ester composite material may also provide additional protection to the glass fibers.

As opposed to UHMWPE fiber, PET fiber will not stiffen the rebar, resulting in low tensile strength and flexural Young's modulus. Furthermore, the processability of the highly flexible concrete reinforcing bar is highly improved, as PET fiber's melting point is appropriate to withstand pultrusion die temperatures, which is not the case for UHMWPE fiber. PET fiber may be opportunistically used in polyester matrix based rebars which are accepted by standards in case of temporary reinforcements, offering better options for a good bonding between PET fiber and polyester matrix.

Furthermore, the highly flexible concrete reinforcing bar according to one or more embodiments of the present disclosure provides more flexibility (i.e., compliance, as opposed to stiffness) in bending, which is distinct from other rebars. Durability of reinforced concrete structures with low load-bearing (i.e., less demanding applications, such as pavement, slab-on-grade, and skin reinforcement) is also improved. Additionally, the highly flexible concrete reinforcing bar described herein has a lower weight and lower embedded energy than existing rebars, resulting in a lower carbon footprint and facilitated installation.

Another advantage is related to the safety of handling the highly flexible concrete reinforcing bar. It is common to machine composite rebars after manufacturing in order to increase their mechanical interlocking with concrete. When peripheral fibers are made of glass, basalt, aramids, or carbon, the result of the machining is a very abrasive surface susceptible to causing injuries to the operators who handle the rebars, and appropriate personal protective equipment is needed. In the case of the highly flexible concrete reinforcing bar, the machining operation does not lead to an abrasive state of surface. In contrast, the surface, or outer portion, is non-abrasive, which alleviates some risks from the handling of rebars. For the purposes of this disclosure, non-abrasive means that the outer portion of the highly flexible concrete reinforcing bar is substantially smooth in texture (i.e., not rough) and will not damage/scratch other surfaces it physically contacts.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A fiber reinforced polymer rebar, comprising:
a first composite comprising glass fibers distributed in a polymer matrix; and
a second composite comprising polyethylene terephthalate fibers distributed in the polymer matrix,
wherein the first composite forms an inner portion of the fiber reinforced polymer rebar,
and the second composite forms an outer portion of the fiber reinforced polymer rebar.

2. The fiber reinforced polymer rebar of claim 1, comprising:
30-70 vol. % of the first composite; and
30-70 vol. % of the second composite.

3. The fiber reinforced polymer rebar of claim 1, comprising:
20-40 vol. % of the polymer matrix;
30-40 vol. % of the glass fibers; and
30-40 vol. % of the polyethylene terephthalate fibers.

4. The fiber reinforced polymer rebar of claim 1, wherein the first composite is bounded by the second composite.

5. The fiber reinforced polymer rebar of claim 1, wherein the polymer matrix comprises a thermoset polymer or a thermoplastic polymer.

6. The fiber reinforced polymer rebar of claim 1, wherein the polymer matrix comprises a vinyl ester resin, a polymethyl methacrylate, an epoxy resin, a polyurethane, or combinations thereof.

7. The fiber reinforced polymer rebar of claim 6, wherein the first composite is a glass fiber reinforced vinyl ester composite, and the second composite is a polyethylene terephthalate fiber reinforced vinyl ester composite.

8. The fiber reinforced polymer rebar of claim 7, wherein the polyethylene terephthalate fiber reinforced vinyl ester composite forms a protective barrier around the glass fiber reinforced vinyl ester composite.

9. The fiber reinforced polymer rebar of claim 1, wherein one or more of the polyethylene terephthalate fibers is modified with functional chemicals to improve adhesion of the fiber reinforced polymer rebar to concrete.

10. The fiber reinforced polymer rebar of claim 9, wherein the functional chemicals comprise one or more of mineral particles, pigments, and chemical additives.

11. The fiber reinforced polymer rebar of claim 1, wherein a surface of the outer portion is non-abrasive.

12. The fiber reinforced polymer rebar of claim 1, characterized by a Young's modulus value between approximately 30 GPa and approximately 35 GPa.

13. The fiber reinforced polymer rebar of claim 1, wherein the glass fibers are distributed radially from a center of the fiber reinforced polymer rebar.

14. A method of forming a fiber reinforced polymer rebar, comprising:
feeding glass fibers and polyethylene terephthalate fibers simultaneously into a resin impregnator, forming a fiber mixture;
pulling the fiber mixture through a liquid polymeric resin in the resin impregnator to form a resin-soaked fiber mixture; and
passing the resin-soaked fiber mixture through a heated stationary die, where resin of the resin-soaked fiber mixture undergoes polymerization and cross-linking to form the fiber reinforced polymer rebar.

15. The method of claim 14, wherein feeding the glass fibers and the polyethylene terephthalate fibers comprises pulling the glass fibers and the polyethylene terephthalate fibers through fiber guiding plates.

16. The method of claim 14, further comprising pulling the glass fibers and the polyethylene terephthalate fibers into the liquid polymeric resin.

17. The method of claim 14, wherein the method comprises controlling a relative volume ratio of the glass fibers and the polyethylene terephthalate fibers.

18. The method of claim 14, wherein the method comprises controlling a distribution of the glass fibers and the polyethylene terephthalate fibers across the fiber reinforced polymer rebar.

19. The method of claim 14, wherein the liquid polymer resin comprises a vinyl ester resin, a polymethyl methacrylate, an epoxy resin, a polyurethane, or combinations thereof.
